(19) United States
(12) Patent Application Publication
(10) Pub. No.: US 2010/0167707 A1
(43) Pub. Date: Jul. 1, 2010

(54) Devices and Methods for Providing Exorbitant Charge Information to a User of a Communication Device

(75) Inventors: Dean E. Thorson, Grayslake, IL (US); William P. Alberth, Crystal Lake, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumberg, IL (US)

(21) Appl. No.: 12/346,024

(22) Filed: Dec. 30, 2008

(51) Int. Cl. H04M 3/493

(52) U.S. Cl. 455/414.2

(57) ABSTRACT

Methods of an out-going call intercept process by a communication device, a communication device, and a server access premium service calls data if an outgoing call communication address is not stored by the communication device in its outgoing call history or in its phonebook. The disclosed methods and device may thwart the fraudulent practice of tricking a user into establishing communication with a premium service calls communication address that they may not otherwise call. The premium service calls data may be stored in the communication device memory, or may be accessed remotely by a remote server. A prompt may be provided by the communication device for authorization to establish an outgoing communication when it is determined that the premium service calls data for the outgoing call communication address meets predetermined criteria. A user may provide authorization to establish a communication in accordance with the outgoing call communication address.

### FIELD

Disclosed are methods of a communication device, communication devices, and servers that determine if an outgoing call is a directed to a premium service calls communication address.

### BACKGROUND

Within the United States, the area codes “900” and “976” are utilized for premium rate call or “pay-per-call” services. Unlike standard telephone services, part of the call charge for a premium rate call is paid to the called party (as payment for a service provided by the called party). A contract between the telephone company and the called party determines the premium rate and the amount to be paid to the called party. United States telephone numbers including area codes 900/976 are regulated by the Federal Trade Commission (FTC). The FTC regulations provide that:

“When you dial a 900 number that costs more than $2, you should hear an introductory message or “preamble.” You can't be charged for this message. It must briefly describe the service, the name of the company providing the service, and the cost of the call. It also must state that anyone under age 18 needs parental permission to complete the call. Once this information is provided, you must be given three seconds to hang up without incurring a charge.”

In other parts of the world, premium service calls are not regulated in the same way or at all. Some calls to area codes outside of the United States include both standard tariff calls and “pay-per-call” services, where premium rates are charged to the caller and divided with the called party. For example, most of the time, calls to Caribbean area code 809 are billed at the standard tariff rate. However, a Caribbean telephone company can contract with a called party to establish a premium service call contract within the 809 area code. Accordingly, the area code of an outgoing call communication address will not necessarily provide enough information to determine if a communication address is a premium service calls communication address.

There is a fraudulent practice involving premium service calls telephone numbers that are outside of the FTC's jurisdiction. The fraudulent practice involves tricking a user into establishing communication with a premium service calls communication address that charges multiple dollars per minute for the call. When the communication is established, the user will be kept on the line for as long as possible so that the user, unknowingly, accrues outrageous fees for the call. In fact, the user will oftentimes not realize that they placed a call to a premium service calls communication address until they receive their monthly statement, or the prepaid phone card is depleted. In some instances, the charge may be substantially higher than the standard telephone service tariff.

One manner in which a user is tricked into establishing communication with premium service calls communication address involves the user returning a missed call. For example, a device having a premium service calls communication address or telephone number or proxy device is used to transmit a call to a user's communication device. When the call is registered by the user's communication device, the call from the premium service calls device is disconnected. The user may attempt to answer the call which, for example, may be disconnected upon answering. Alternatively, the user's device may ring just once before the call is disconnected. The communication device, having received such a call, may annunciate that a call has been missed. Polite people, who are simply returning a missed call, would then be charged multiple dollars per minute for the call, which are shared with the called party per a billing agreement between the telephone company and the called party.

A variation of the scam is that a user may receive a voicemail, SMS, MMS, or email saying a relative/friend has died/been arrested/hospitalized and that the user needs to call a telephone number, which is a premium service calls communication address. Another manner in which to trick a user may include a message of any type that the user has won a prize, and to claim it the user needs to call a number, which is a premium service calls communication address. Another manner may be to place a public notice in, for example, a newspaper, advertising an employment opportunity to trick a user to call the premium service calls communication address. In any event, by being tricked into placing a call to the premium service calls communication address, a user will unknowingly be charged multiple dollars per minute for the call.

There is an opportunity to help users avoid inadvertently incurring premium rates when calling communication addresses where the FTC has no jurisdiction and especially to communication addresses with area codes that include both standard tariff calls and “pay-per-call” services.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an embodiment of a system including a communication device, a premium service calls device, and a server; and

FIG. 2 is a signal diagram illustrating an embodiment of a method of accessing data stored on the communication device and/or the server relating to premium service calls data.

### DETAILED DESCRIPTION

Disclosed are methods of an out-going call intercept process by a communication device, a communication device, and a server to access premium service calls data if an outgoing call communication address is not stored by the communication device in its outgoing call history or in its phonebook. That is, if the communication device receives an outgoing call communication address for call placement, but it is the first time in its memory of placing an outgoing call to that communication address, then the communication device will access premium service calls data before establishing communication in accordance with the outgoing call communication address. The premium service calls data may include information such as the billing rate for calling the outgoing call communication address. The premium service calls data may be stored in the communication device memory, or it may be accessed from a remote server. In this manner, the fraudulent practice of tricking a user into establishing communication with a premium service calls communication address that they may not otherwise call may be thwarted by the disclosed out-going call intercept process.

The disclosed method may further include establishing communication in accordance with the outgoing call communication address when it is determined that the premium service calls data for the outgoing call communication address meets predetermined criteria. A prompt may be provided by the communication device requesting authorization to establish a communication in accordance with the outgoing call communication address when it is determined that the premium service calls data for the outgoing call communication address meets predetermined criteria that includes exceeding a particular threshold premium service calls value. A user may provide authorization to establish a communication to the outgoing call communication address.

The premium service calls data may be established in any suitable manner. For example, a “white list” may be compiled with various communication addresses and their related charges to provide charge information to users of communication devices to mitigate fraudulent practices proliferated by some businesses or service providers. The same list may include known area codes or other numeric sequences of premium service calls communication addresses and their related per-minute or minimum per-call or premium values.

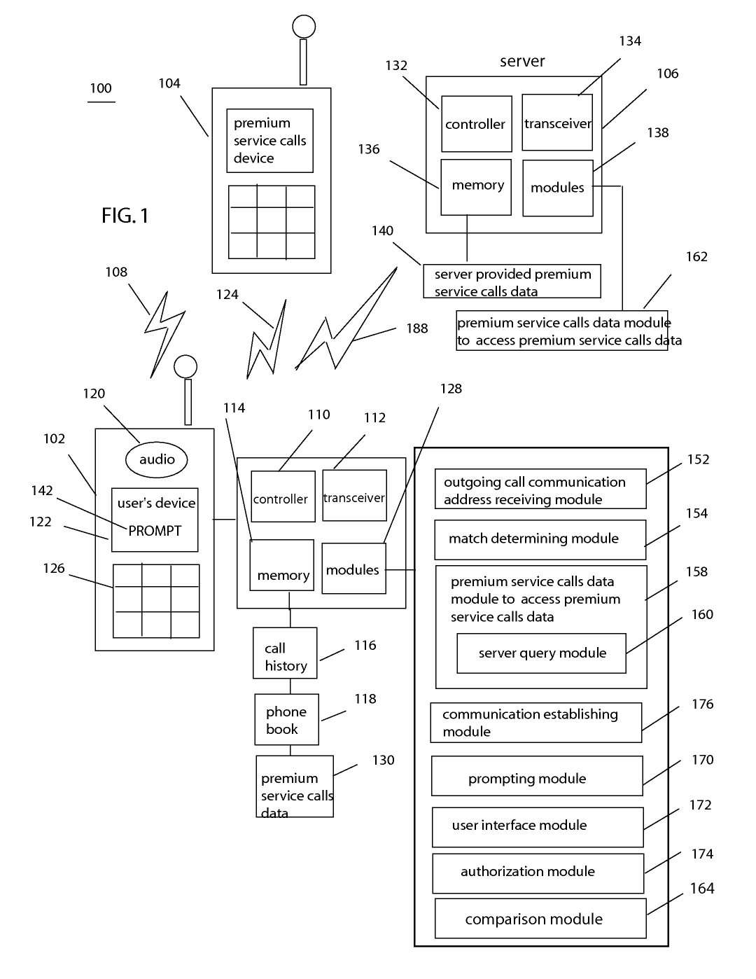

FIG. 1 illustrates an embodiment of a system 100 including a communication device 102, here called a user's device 102, a premium service calls device 104, and a server 106. The communication device 102 may be implemented as a mobile communication device such as a cellular telephone (also called a mobile phone) or pager. The communication device 102 represents a wide variety of devices that have been developed for use within various networks including wireless and wired telephone networks and wireless and wired computer networks. Herein, communication technologies may include, for example, voice communication and/or voice over internet protocol (VoIP) communication.

As mentioned previously, a user may be tricked into calling a premium service calls device 104 in any number of ways. The premium service calls device 104 can be any type of communication device including those that are wired and those that are wireless. For example, device 104 having a premium service calls communication address or telephone number or an alternative proxy device can be used to transmit a call 108 to a user's device 102. For purposes of clarity, details of conventional circuit-switched and packet-switched network infrastructure (e.g., public switched telephone network, the Internet, wired and wireless wide area network infrastructure, wired and wireless local area network infrastructure, etc.) are omitted.

The user's device 102, including a controller 110 may register the call from premium service calls device 104 or its proxy using a transceiver 112. One or more memory devices 114 of the user's device 102 in communication with the controller 110, can store outgoing call history data 116 and/or phonebook data 118 that may or may not include the communication address of premium service calls device 104.

When placing a call to the premium service calls device 104, the user's device 102 can receive an outgoing call communication address in any number of manners. For example, if a call 108 is received by the user's device 102, it may register as a missed call. For example, a missed call message may be established when a communication is received from the premium service calls device 104 and terminated within a predetermined period of time. The predetermined period of time can be any time sufficient to establish a missed call message by the user's communication device 102.

If the user misses the call on the user's device, a missed call message may be annunciated by playing an audible “missed call” tone through the communication device's speaker 120 and/or by displaying a “missed call” message or icon on the communication device's display 122. To initiate an outgoing call 124 to the communication address of the missed call, the user may simply press “send” in response to a missed message prompt. In the one example, the user can access the missed call communication address of the terminated call by navigating a received calls menu. In another instance, the user can access the missed call communication address by responding to a missed call audible or visible prompt.

As mentioned, there are any number of methods in which the user's device 102 can receive an outgoing call communication address so that an outgoing call 124 can be placed. In another example, a user may input the communication address on a keypad 126 of the user's device 102. However, before such an outgoing call 124 is completely processed, the disclosed out-going call intercept process can make a determination, in accordance with a plurality of embodiments, whether the outgoing call will be to a premium service calls telephone number and/or whether the premium service calls data relating to such an outgoing call meets predetermined criteria.

The premium service calls data predetermined criteria may include a threshold monetary value. Such a threshold value may be, for example, a charge that is “reasonable and customary.” If a determination is made that a call to the premium service calls communication address will not exceed a particular threshold premium service calls value, the call may be allowed to proceed. For example, if the premium service calls value is, e.g., ten cents per minute or ten cents a minute above a standard tariff rate, such a fee may be acceptable to a user. On the other hand, above that rate or pay-per-call value, the fee may not be acceptable to a user. The premium service calls information may meet predetermined criteria that includes “a call to the premium service calls communication address will exceed a particular threshold premium service calls value”. In that case, the user's device prompts the user as to whether the call should be connected. It is understood that the determination of a threshold value may be set by default, may be user set, may be the result of a downloaded program, or may be provided in any other suitable manner. The threshold value may be determined in various ways, such as by a per-minute charge, a minimum charge per call, or a premium above a standard tariff rate per minute. The value may be in currency or credits, such as calling-minute credits.

The mobile communication device 102 may further include modules 128. The modules can carry out certain processes of the methods as described herein. Steps of methods may involve modules and modules may be inferred by the methods discussed herein. The modules can be implemented in software, such as in the form of one or more sets of prestored instructions, and/or hardware, which can facilitate the operation of the communication device as discussed below. The modules may be installed at the factory or can be installed after distribution by, for example, a downloading operation. The operations in accordance with the modules will be discussed in more detail below.

An outgoing call to an outgoing call communication address may be processed in accordance with an outgoing call communication address receiving module 152. A match determining module 154 can determine if it is the first time in its memory 114 that the user's device 102 places an outgoing call to a particular outgoing call communication address. In one embodiment, the match determining module 154 can determine if there is no match of the outgoing call communication address with outgoing call history data 116 or phonebook data 118. If there is a match with the outgoing call history data 116 or phonebook data 118, a communication establishing module 176 can place an outgoing call to the outgoing call communication address. If, however, there is no match of the outgoing call communication address, the communication establishing module 176 establishes communication if it is determined that the premium service calls data for the outgoing call communication address meets predetermined criteria.

If it is the first time in its memory 114 that the user's device 102 receives a particular outgoing call communication address, the method of the user's device can include accessing premium service calls data 130 stored in one or more memory devices 114 of the user's device 102 and/or a remote server 106 via any type of suitable communication channel 188. That is, premium service calls data 130 and/or premium service calls data 140 can be accessed on the user's device 102 and/or on the remote server 106.

If premium service calls data 130 is stored in a memory 114 of the user's device 102, it may be determined that premium service calls information for a particular outgoing call communication address is unavailable. In that event a server query module 160 within the premium service calls data module 158 may send a query to the server 106 via channel 188.

The server 106 can include a controller 132, a transceiver 134, a memory 136, and modules 138. When queried by the user's device 102 in accordance with the server query module 160, the server 106, in accordance with its premium service calls data module 162 can access premium service calls data 140 and use its transceiver 134 to transmit the result to the user's device 102. In the alternative, the user's device 102 may not store such information at all, and the server query module 160 may send a query over a communication channel 188 to the server 106 whenever an outgoing call communication address is not stored in the outgoing call history 116 or address book 118 of the user's device 102.

The server 106 may be of any suitable configuration. The server 106 may be implemented as a single server or as a plurality of servers in communication in any arrangement and/or may be part of any suitable network. The operations of the server 106 may be distributed among different servers or devices that may communicate in any manner.

It is understood that the depiction of devices in FIG. 1 is for illustrative purposes. An update of the premium services call data 130 and/or 140 may be on a scheduled basis (e.g., every Sunday night). If no premium services calls data 130 and/or 140 is available for a particular outgoing call communication address, then a standard tariff rate is assumed.

A prompting module 170 can provide a prompt to the user requesting authorization to establish communication in accordance with the outgoing call communication address when it is determined that the premium service calls data meets predetermined criteria that includes exceeding a threshold premium service calls value. The prompt may be via an audio component 120 configured to receive a prompting signal from the prompting module to generate an audio prompt. The prompt may be a visual prompt 142 generated by a display output component 122 configured to receive a prompting signal from the prompting module to generate a visible prompt 142. A user interface input module 172 for receiving a response to a prompt of the prompting module 170 may receive a response to any type of prompt provided by the prompting module 170. A prompting module 170 executable by the controller 110 may annunciate a prompt when it is determined, for example, that the premium service calls data meets predetermined criteria such as exceeding a particular threshold premium service calls monetary value.

An authorization module 174 can receive the user's response to the prompt. If the user's response indicates that authorization is given, then the outgoing call is placed using communication establishing module 176. Otherwise, the outgoing call is canceled. The method can further include establishing communication using communication establishing module 176 without a prompt for authorization when it is determined that the premium service calls data value is equal to or below a particular threshold value.

The premium service calls data 130 of the user's device 102 and/or the server-provided premium service calls data 140 may be based on at least a portion of the outgoing call communication address. The communication address of the premium service calls device may include an area code or a country code, or a combination of an area code and country code, or any other numerical, alphanumeric or other sequence that can be used to identify a communication address as a premium service communication address. As mentioned, in the United States, a 900 or 976 area code is used as premium service calls communication addresses. The premium service calls data memory module may include such information, and can be updated either automatically by the network operator, manually by the network operator, or by user instruction. Note that the network operator could add premium service calls data based on customer complaints, analysis of customer charges, knowledge regarding telephone service operator premium service calls contracts, and the like. The premium service calls data memory module may also store the charges involved with calling a known or suspected premium service calls device.

In this way, a user of a communication device could be notified of an excessive call charging rate prior to the call being connected, and thus usurp the fraudulent practice that includes keeping the user of the communication device on the line for a substantial period of time without the user's knowledge of the excessive call charging rates.

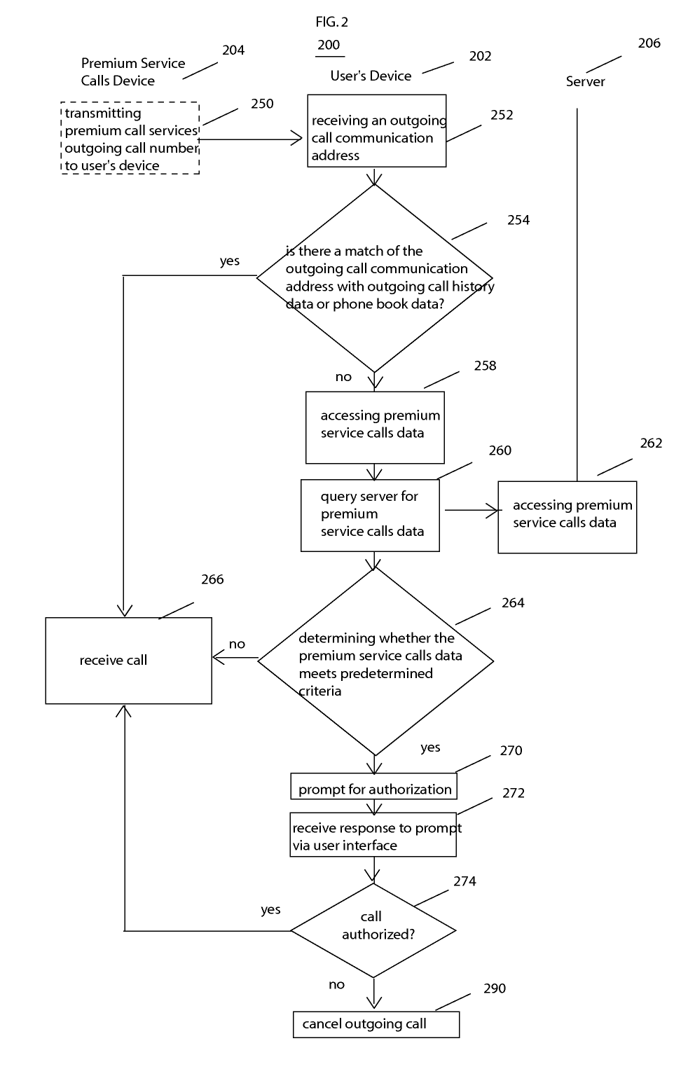

FIG. 2 is a signal flow diagram 200 illustrating an embodiment of a method of accessing data stored on a communication device 202 (such as communication device 102 shown in FIG. 1) and/or a server 206 (such as server 106 shown in FIG. 1) relating to premium service calls data before establishing an outgoing communication 124 (see FIG. 1) to a premium service calls device 204 (such as premium service calls device 104 shown in FIG. 1). As mentioned above, a premium service calls device 204 or its proxy may place 250 an incoming call to a user's device 202 and a user respond to that missed call so that the user's device 202 receives an outgoing call communication address 252 in accordance with outgoing call communication address receiving module 152 (see FIG. 1). As mentioned previously, an outgoing call communication address can alternately be received by the user's device 202 in any number of manners, such as responding to a text message or directly entering in the outgoing call communication address through a keypad 126 (see FIG. 1).

The user's device 202 may then, in accordance with a match determining module 154 (see FIG. 1) determine 254 whether the outgoing call communication address matches outgoing call history data or phonebook data. In other words, the user's device 202 can determine whether in its memory 114 an outgoing call has previously been made to the outgoing call communication address or whether the communication address is in the address book of the user's device 202. If yes, then a call may routinely be placed 266 to the premium service calls device 204 using communication establishing module 176. If there is no match to the memory 114 that an outgoing call has been made to the outgoing call communication address or is stored in the address book, a premium service calls data module 158 can access 258 premium service calls data from a memory of the user's device 202 and/or query 260 premium service calls data from a remote server 206.

The user's device 202 in accordance with the server query module 160 can transmit a query 260 to a remote server 206 to access 262 the server's premium service calls data 140 in accordance with the server's premium service calls data module 162. Various scenarios for making such a server query 260 were discussed above with reference to FIG. 1. After it is determined that the outgoing call communication address is a premium service calls communication address, it can be determined 264 whether the premium service calls data meets predetermined criteria.

Examples of predetermined criteria were discussed previously. If for example, the rate for a call to the premium service calls communication address is equal to or below a threshold, the communication establishing module 176 (see FIG. 1) may allow a call to be placed 266 to the device 204 without a prompt to the user. However, if it is determined 264 that the rate for a call to the outgoing call communication address is above a threshold, the user's device 202 may prompt 270 the user in accordance with the prompting module 170. As discussed above, the prompt for authorization may be provided in various manners. In one embodiment, an audible prompt in accordance with an audio component 120 may provide a prompt such as: “This call will be billed at $23 per minute. Press 1 if you would like to complete the call. Press END if you would like to cancel the call.” In the event that the user does not wish to proceed with the call, the user may not press 1, or may provide any other indication that authorization is not given so that the outgoing call to the premium service calls device 204 is not placed.

The response to the prompt 270 may be received 272 via a user interface in accordance with the user interface module 172. If the authorization module 174 determines 274 that the user has not authorized an outgoing call to the outgoing call communication address, then the outgoing call is canceled 290. If the authorization module 174 determines 274 that the user has authorized an outgoing call to the outgoing call communication address, the communication establishing module 176 can establish communication in accordance with the outgoing call communication address. The call may accordingly be received 266 by the premium service calls device 204 after the disclosed outgoing call intercept process has thwarted attempts to trick the user into unknowingly making expensive calls. Additional steps may be added to the discussed methods, such as blocking incoming and/or outgoing calls from a premium service calls communication address.

The disclosed methods of out-going call intercept by a communication device, communication devices and servers including premium service calls data may help to mitigate fraudulent practices proliferated by some owners of premium service calls devices. In this way a user of a communication device could be notified of an excessive charging rate of making a call prior to the call being connected, and thus usurp the fraudulent practice that includes keeping the user of the communication device on the line for a substantial period of time without the user's knowledge that the outgoing communication address is to a premium service calls device.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims. It is understood that the use of relational terms, if any, such as first and second, up and down, and the like are used solely to distinguish one from another entity or action without necessarily requiring or implying any actual such relationship or order between such entities or actions.

At least some inventive functionality and inventive principles may be implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

We claim:

1. A method of a communication device including a memory storing outgoing call history data and phonebook data, comprising:
receiving an outgoing call communication address;
determining whether the outgoing call communication address matches outgoing call history data or phonebook data;
accessing premium service calls data if there is no match of the outgoing call communication address with outgoing call history data or phonebook data; and
establishing communication in accordance with the outgoing call communication address when it is determined that the premium service calls data meets predetermined criteria.

2. The method of claim 1 wherein accessing premium service calls data comprises:
accessing premium service calls data stored on the communication device.

3. The method of claim 2 wherein accessing premium service calls data further comprises:
accessing premium service calls data stored on a remote server when accessing premium service calls data stored on the communication device results in unavailable premium service calls data.

4. The method of claim 1 wherein accessing premium service calls data comprises:
accessing premium service calls data stored on a remote server.

5. The method of claim 1 wherein establishing communication in accordance with the outgoing call communication address when it is determined that the premium service calls data meets predetermined criteria, comprises:
providing a prompt by the communication device for authorization to establish a communication in accordance with the outgoing call communication address when it is determined that the premium service calls data meets predetermined criteria that includes exceeding a particular threshold premium service calls value; and
receiving authorization.

6. The method of claim 1 wherein establishing communication in accordance with the outgoing call communication address when it is determined that the premium service calls data meets predetermined criteria, comprises:
establishing communication without a prompt for authorization to establish the communication in accordance with the outgoing call communication address when it is determined that the premium service calls data meet predetermined criteria that includes having premium service calls value equal to or below a particular threshold value.

7. The method of claim 1 wherein receiving the outgoing call communication address is in response to an incoming communication.

8. The method of claim 1 wherein receiving the outgoing call communication address is in response to a terminated incoming communication.

9. A communication device, comprising:
a controller;
a transceiver coupled to the controller configured to receive communication from a communication address;
a memory coupled to the controller, the memory storing outgoing call history data and phonebook data;
an outgoing call communication address receiving module coupled to the controller to receive an outgoing call communication address;
a match determining module coupled to the controller to determine whether the outgoing call communication address matches outgoing call history data or phonebook data,
a premium service calls data module coupled to the controller for accessing premium service calls data if the match determining module determines that the outgoing call communication address fails to match outgoing call history data or phonebook data; and
a communication establishing module coupled to the controller to establish a communication in accordance with the outgoing call communication address when it is determined that the premium service calls data related to the outgoing call communication address meets predetermined criteria.

10. The communication device of claim 9 wherein the premium service calls data module accesses premium service calls data stored on the communication device.

11. The communication device of claim 10 wherein the premium service calls data module accesses premium service calls data stored on a remote server when accessing premium service calls data stored on the communication device results in unavailable premium calls data related to the outgoing call communication address.

12. The communication device of claim 9 wherein accessing premium service calls data module accesses premium service calls data stored on a remote server.

13. The communication device of claim 9 further comprising:
a prompting module coupled to the controller for providing a prompt by the communication device for requesting authorization to establish the communication in accordance with the outgoing call communication address when it is determined that the premium service calls data related to the outgoing call communication address meets predetermined criteria that includes exceeding a particular threshold premium service calls value; and
an authorization module coupled to the controller to determine whether authorization has been received for establishing an outgoing call to the outgoing call communication address.

14. The communication device of claim 13, further comprising:
an audio output component coupled to the controller to receive a prompting signal from the prompting module to generate an audio prompt.

15. The communication device of claim 13, further comprising:
a display output component coupled to the controller to receive a prompting signal from the prompting module to generate a visible prompt.

16. The communication device of claim 13, further comprising:
a user interface input module for receiving a response to the prompt of the prompting module.

17. A method of a communication system, having a server and a communication device with a memory storing outgoing call history data and phonebook data, comprising:
the communication device receiving an outgoing call communication address;
the communication device determining whether the outgoing call communication address matches outgoing call history data or phonebook data,
the communication device accessing premium service calls data on the server if there is no match of the outgoing call communication address with outgoing call history data or phonebook data.

18. The method of claim 17 wherein the method further comprises:
the communication device establishing communication in accordance with the outgoing call communication address when it is determined that the premium service calls data meets predetermined criteria.

19. The method of claim 18 wherein the method further comprises:
the communication device providing a prompt requesting authorization to establish a communication in accordance with the outgoing call communication address when it is determined that the premium service calls data meets predetermined criteria that includes exceeding a particular threshold premium service calls value; and
the communication device receiving authorization.

20. The method of claim 18 further comprising:
the communication device accessing premium service calls data stored in the communication device; and
the communication device determining that no premium service calls data stored in the communication device is related to the outgoing call communication address.
